(19) United States
(12) Patent Application Publication
(10) Pub. No.: US 2024/0229462 A9
(43) Pub. Date: Jul. 11, 2024

(54) GYPSUM BOARD

(71) Applicant: Lior ROZENTAL, Raanana (IL)

(72) Inventor: Lior ROZENTAL, Raanana (IL)

(21) Appl. No.: 18/277,604

(22) PCT Filed: Feb. 21, 2022
(86) PCT No.: PCT/IL2022/050199

§ 371 Date: Aug. 17, 2023

Related U.S. Application Data
(60) Provisional application No. 63/151,812, filed on Feb. 22, 2021.

(51) Int. Cl. E04C 2/52; E04C 2/04

(52) U.S. Cl. CPC E04C 2/526; E04C 2/044; B28B 23/005

(57) ABSTRACT

A gypsum board (10A), including: a gypsum panel (58); and a plurality of anchors (28) fixed to the gypsum panel (58) and sunk within for not protruding therefrom, the anchors (28) being hidden by a first side (47B) of the gypsum panel (58).

### TECHNICAL FIELD

The invention relates to the field of gypsum boards.

### BACKGROUND

FIG. 1 is a top view of prior art gypsum boards disposed one aside the other.

Prior art gypsum boards 14 do not include any connecting means, and no protrusions, thus may be neatly attached one to the other for storing and transferring.

FIG. 2 is a top view of the prior art gypsum boards of FIG. 1, being connected to one another.

Each prior art gypsum board 14 includes two paper sheets 43, and a cast gypsum panel 58 therebetween.

Connection of gypsum board 14 to an metal profile 18A is applied by screws 16 threaded by rotation, through gypsum board 14 and therefrom into profile 18A.

However, the head of the bolts are viewed, thus must be covered and then the gypsum board must be painted.

There is a long felt need to provide a solution to the above-mentioned and other problems of the prior art.

### SUMMARY

A gypsum board, including:
a gypsum panel; and
anchors fixed to the gypsum panel.

### BRIEF DESCRIPTION OF THE DRAWINGS

Embodiments, features, and aspects of the invention are described herein in conjunction with the following drawings:

FIG. 1 is a top view of prior art gypsum boards disposed one aside the other.

FIG. 2 is a top view of the prior art gypsum boards of FIG. 1, being connected to one another.

FIG. 3 is a top view of a gypsum board kit according to one embodiment of the invention.

FIG. 4 is a top view of gypsum boards like those of FIG. 3 disposed one aside the other.

FIG. 5 is a top view of the gypsum boards of FIG. 4, being connected to one another.

FIG. 6 is a top view of a gypsum board according to another embodiment.

FIG. 7 is a perspective view of the bolt anchor and of the bolt at the non-protruding state of FIG. 6.

FIG. 8 is the top view of FIG. 6 upon protruding the bolt.

FIG. 9 is a perspective view of the bolt anchor and of the bolt at the protruding state of FIG. 8.

FIG. 10 is a front sectional view of a bolt anchor and of the bolt according to another embodiment, at a protruding state.

FIG. 11 depicts producing the gypsum board of FIG. 3 and other figures according to one embodiment.

FIG. 12 depicts the first step of producing the gypsum board of FIG. 3 and other figures according to another embodiment.

FIG. 13 depicts the second step of producing the gypsum board of FIG. 3.

FIG. 14 depicts the second step of producing the gypsum board of FIG. 3.

The drawings are not necessarily drawn to scale.

### DETAILED DESCRIPTION

The invention will be understood from the following detailed description of embodiments of the invention, which are meant to be descriptive and not limiting. For the sake of brevity, some well-known features are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

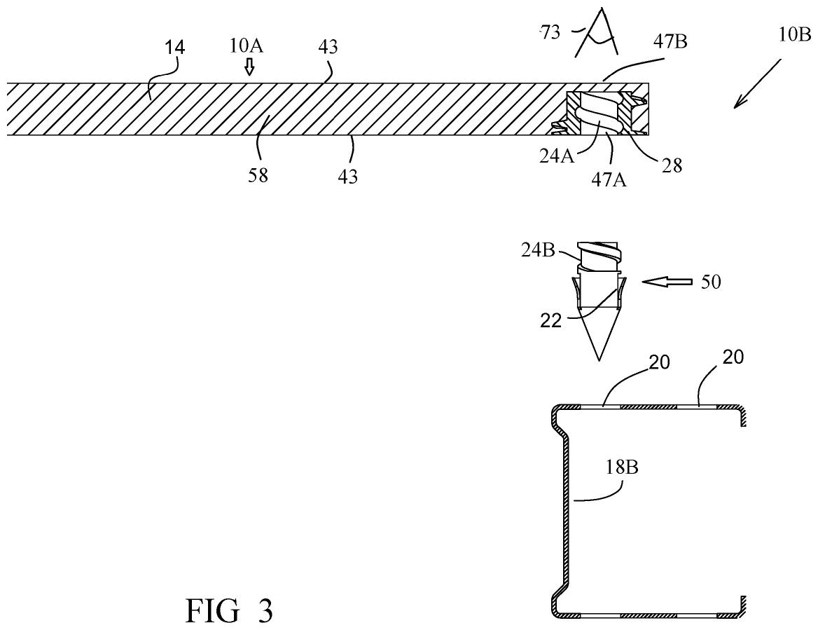

FIG. 3 is a top view of a gypsum board kit according to one embodiment of the invention.

A gypsum board kit 10B according to one embodiment includes gypsum boards 10A according to the invention; bolts 50 each including a fastening element 22, such as a springy snapping element; and holes 20 within a profile 18B, each for receiving fastening element 22.

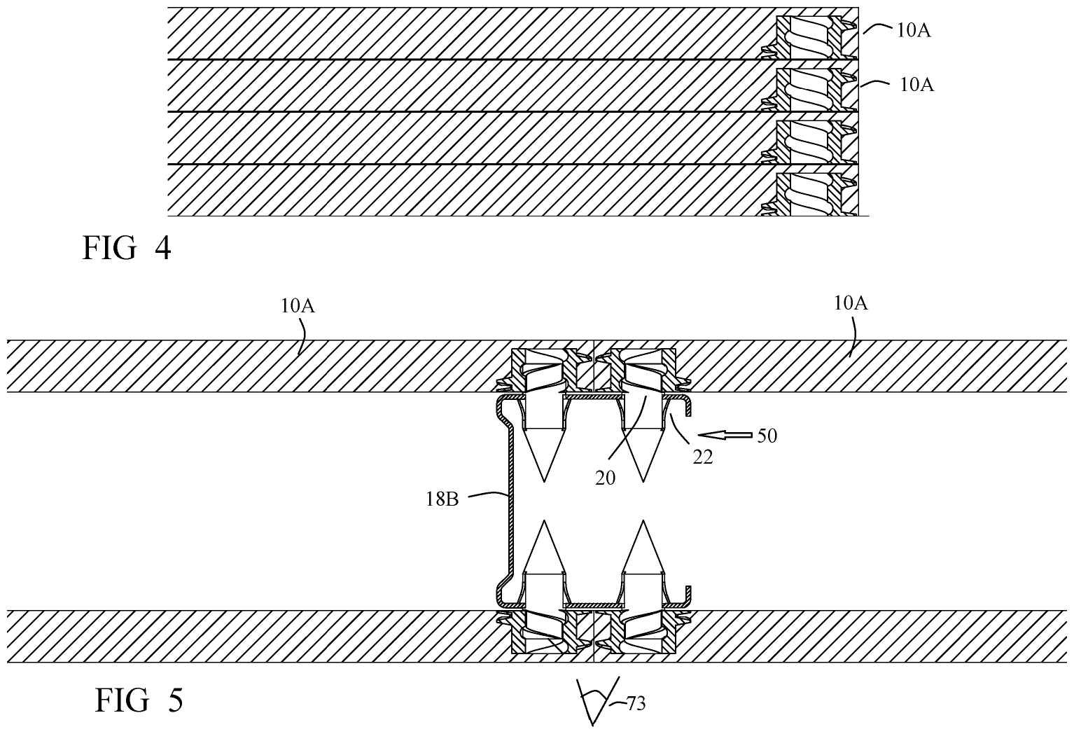

FIG. 4 is a top view of gypsum boards like those of FIG. 3 disposed one aside the other.

Gypsum boards 10A include anchors 28 for bolts 50, while not including any protrusions, thus gypsum boards 10A may be neatly attached one to the other for storage and transportation.

FIG. 5 is a top view of the gypsum boards of FIG. 4, being connected to one another.

Connection of gypsum board 10A to an metal profile 18B is applied by inserting snapping elements 22 of bolt 50 into hole 20 of profile 18B, for being snapped thereby.

Referring again to FIG. 3, gypsum board 10A includes two paper sheets 43; cast gypsum panel 58 therebetween; and bolt anchors 28 fixed to gypsum panel 58 from side 47A and sunk within for not protruding therefrom. Anchors 28 are hidden from eye 73 by surface 47B, including at least paper sheet 43.

Thus, kit 10B is advantaged in that at the connected state, bolts 50 protrude out of the board, and are hidden by side 47B; and that at the storage state, bolts 50 do not protrude out of side 47A of the board.

According to one embodiment, each bolt anchor 28 includes a female thread 24A; and bolt 50 includes a male thread 24B for being threadable into female thread 24A.

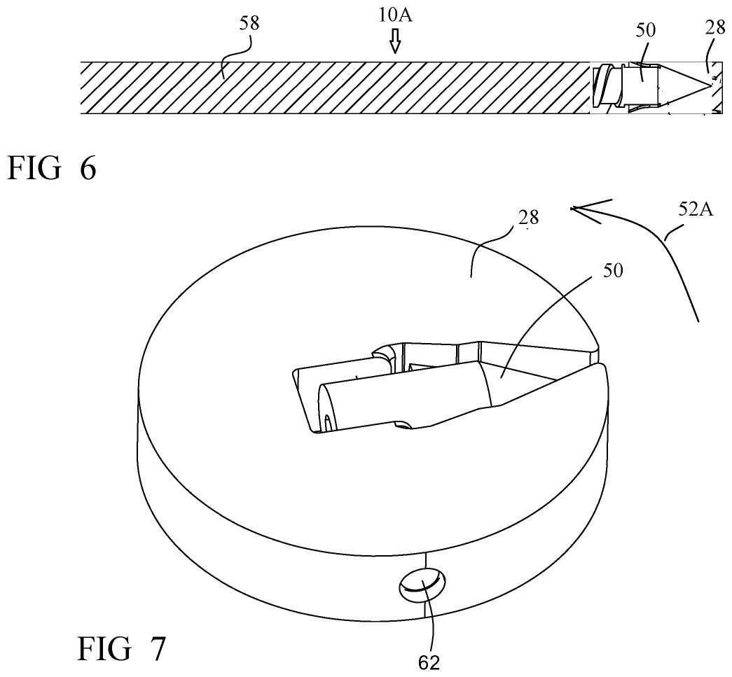

FIG. 6 is a top view of a gypsum board according to another embodiment.

Gypsum board 10A may include bolts 50, being fixed to gypsum panel 58 by bolt anchors 28, while not protruding at the storage state.

FIG. 7 is a perspective view of the bolt anchor and of the bolt at the non-protruding state of FIG. 6.

Bolt 50 is rotatable (52A) in relation to bolt anchor 28 via a hinge 62.

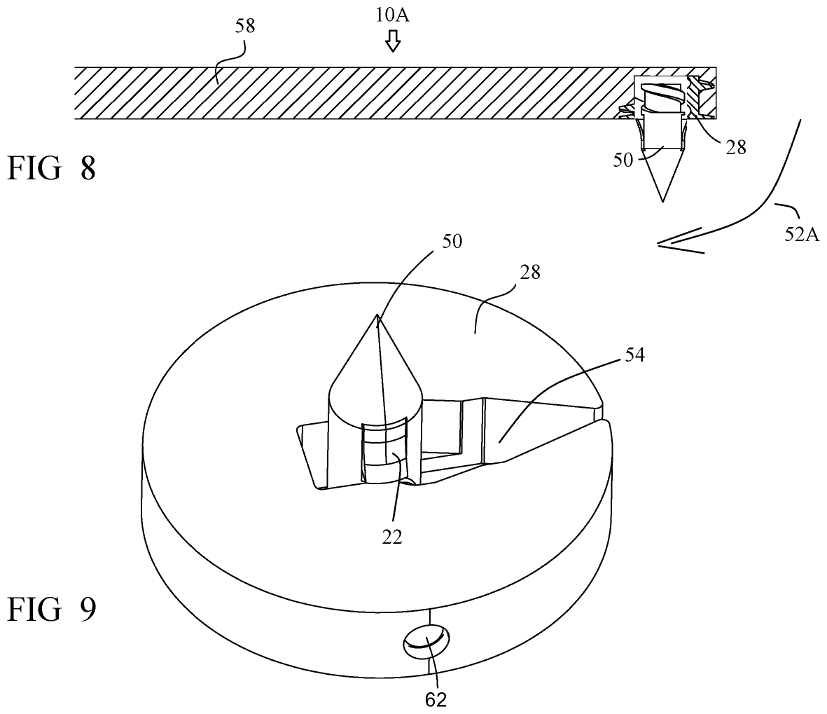

FIG. 8 is the top view of FIG. 6 upon protruding the bolt.

Bolt 50 may be rotatable (52A) for protruding it out of bolt anchor 28.

FIG. 9 is a perspective view of the bolt anchor and of the bolt at the protruding state of FIG. 8.

Bolt anchor 28 includes a niche 54 for housing bolt 50 at the non-protruding state.

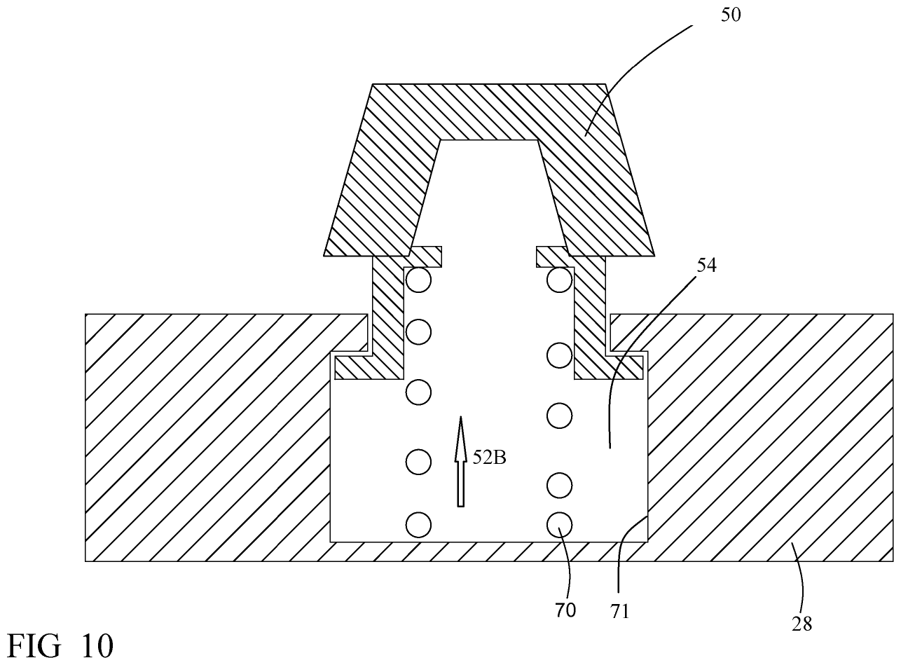

FIG. 10 is a front sectional view of a bolt anchor and of the bolt according to another embodiment, at a protruding state.

Bolt 50 may be slideable (52B) along a track 71 of anchor 28, for protruding it out of bolt anchor 28, and may include a spring 70 for maintaining the protruded state.

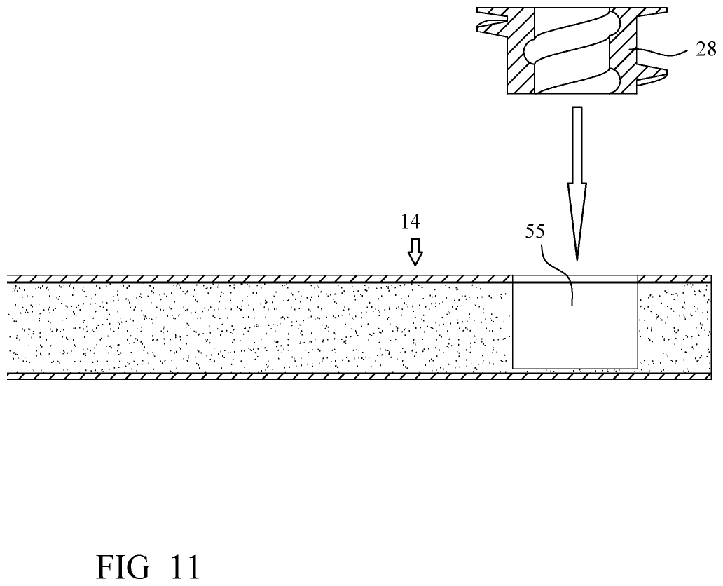

FIG. 11 depicts producing the gypsum board of FIG. 3 and other figures according to one embodiment.

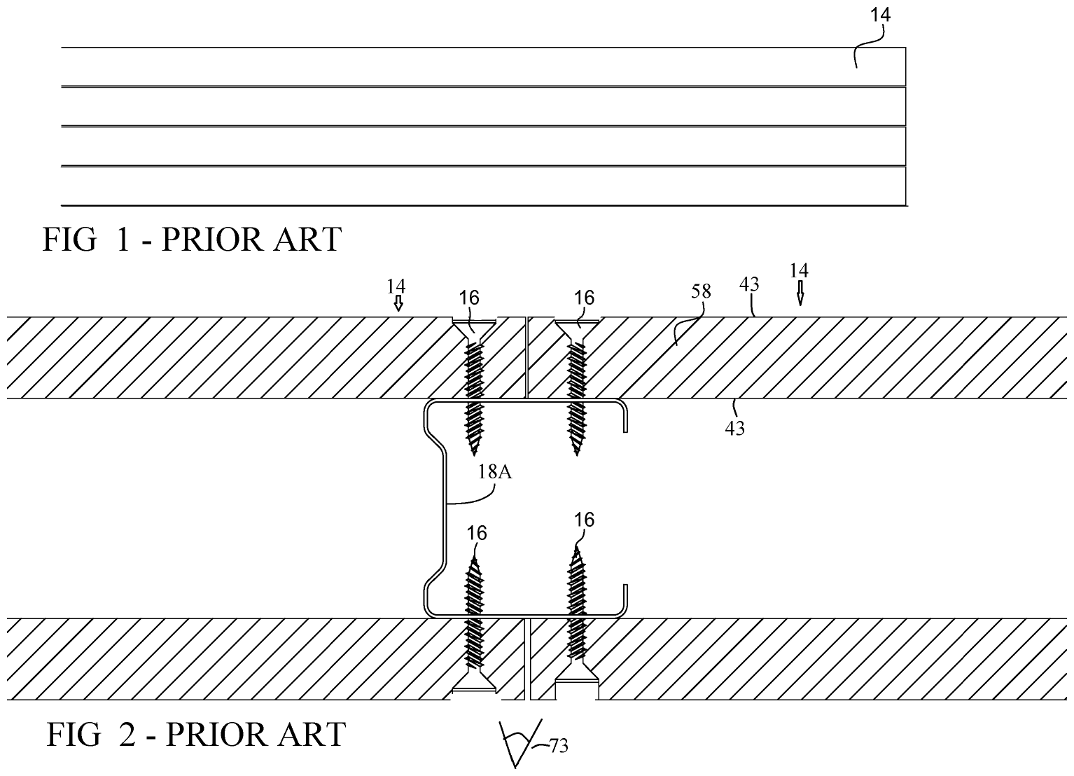

Prior art gypsum board 14 of FIG. 1 may be drilled to form a hole 55, for then thrusting bolt anchor 28.

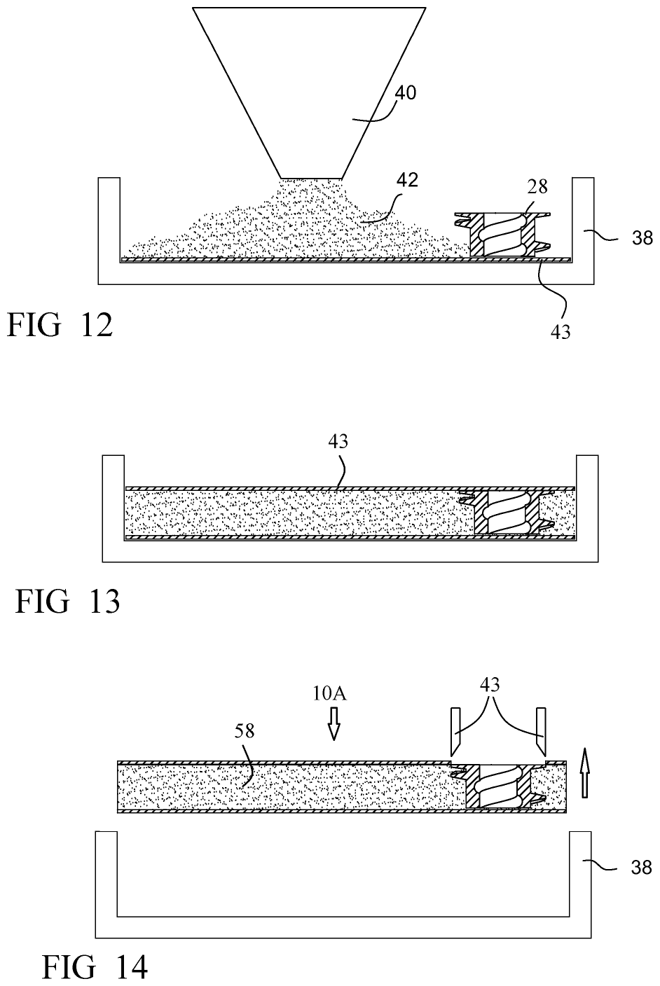

FIG. 12 depicts the first step of producing the gypsum board of FIG. 3 and other figures according to another embodiment.

According to another embodiment, gypsum board 10A is produced by deploying bottom paper sheet 43 on a mold 38; then disposing bolt anchors 28 on paper sheet 43; and then pouring powder/liquid plaster 42 into mold 38.

FIG. 13 depicts the second step of producing the gypsum board of FIG. 3.

Then, deploying a top paper sheet 43.

FIG. 14 depicts the second step of producing the gypsum board of FIG. 3.

Upon solidification of powder/liquid plaster 42 to form gypsum panel 58 fixing anchors 28, removing the gypsum board from mold 38.

Thus, in one aspect, the invention is directed to a gypsum board (10A), including:
a gypsum panel (58); and
a plurality of anchors (28) fixed to the gypsum panel (58) and sunk within for not protruding therefrom, the anchors (28) being hidden by a first side (47B) of the gypsum panel (58).

The gypsum board (10A) may further include:
a bolt (50), for each of the anchors (28), for being anchored thereby, to protrude from a second side (47A) of the gypsum panel (58) vertically thereto.

The bolt (50) may include a fastening element (22), for fastening a profile (18B).

The gypsum board (10A) may further include:
a profile (18B) including at least one female fastening element (20) for being fastened by the fastening element (22) of the bolt (50).

Each of the anchors (28) may be separable from the bolt (50) thereof, and
include a female thread (24A), for threading thereinto a male (24B) thread of the bolt (50),
thereby allowing to protrude the bolt (50) from the second side (47A) of the gypsum panel (58) vertically thereto, and to cancel the protruding.

Each of the anchors (28) may be non-separable from the bolt (50) thereof, and
include a hinge (62), for rotating (52A) the bolt (50) thereof in relation to the anchor (28),
thereby allowing to protrude the bolt (50) from the second side (47A) of the gypsum panel (58) vertically thereto, and to cancel the protruding.

Each of the anchors (28) may be non-separable from the bolt (50) thereof, and
include a track (71), for sliding (52B) the bolt (50) thereof in relation to the anchor (28),
thereby allowing to protrude the bolt (50) from the second side (47A) of the gypsum panel (58) vertically thereto, and to cancel the protruding.

The fixing of anchors 28 to gypsum panel 58 may apply solidifying liquid plaster 42 onto anchors 28.

In the figures and/or description herein, the following reference numerals (Reference Signs List) have been mentioned:
numeral 10A denotes the gypsum board according to one embodiment of the invention;
10B: gypsum board kit;
14: prior art gypsum board;
16: self-tapping screw;
18A: profile adapted to prior art gypsum board 14;
18B: profile adapted to gypsum board 10A;
20: hole or other female fastening element;
24A: female thread;
24B: male thread;
28: anchor;
40: receptacle;
42: powder/liquid plaster;
43: paper sheet;
47A, 47B: sides of gypsum board 10A;
50: bolt;
52A: rotating bolt 50;
52B: sliding bolt 50;
54: niche for housing bolt 50;
55: drilled hole;
58: gypsum panel;
62: hinge;
70: spring;
71: track;
73: eye viewing the gypsum board;

The foregoing description and illustrations of the embodiments of the invention have been presented for the purpose of illustration, and are not intended to be exhaustive or to limit the invention to the above description in any form.

Any term that has been defined above and used in the claims, should be interpreted according to this definition.

The reference numbers in the claims are not a part of the claims, but rather used for facilitating the reading thereof. These reference numbers should not be interpreted as limiting the claims in any form.

What is claimed is:

1. A gypsum board (10A), comprising:
a gypsum panel (58); and
a plurality of anchors (28) fixed to said gypsum panel (58) and sunk within for not protruding therefrom, said anchors (28) being hidden by a first side (47B) of said gypsum panel (58).

2. The gypsum board (10A) according to claim 1, further comprising:
a bolt (50), for each of said anchors (28), for being anchored thereby, to protrude from a second side (47A) of said gypsum panel (58) vertically thereto.

3. The gypsum board (10A) according to claim 2, wherein said bolt (50) comprises a fastening element (22), for fastening a profile (18B).

4. The gypsum board (10A) according to claim 3, further comprising:
a profile (18B) comprising at least one female fastening element (20) for being fastened by said fastening element (22) of said bolt (50).

5. The gypsum board (10A) according to claim 2, wherein each of said anchors (28) is separable from the bolt (50) thereof, and
comprises a female thread (24A), for threading thereinto a male (24B) thread of said bolt (50),
thereby allowing to protrude the bolt (50) from said second side (47A) of said gypsum panel (58) vertically thereto, and to cancel said protruding.

6. The gypsum board (10A) according to claim 2, wherein each of said anchors (28) is non-separable from the bolt (50) thereof, and
comprises a hinge (62), for rotating (52A) the bolt (50) thereof in relation to the anchor (28),
thereby allowing to protrude the bolt (50) from said second side (47A) of said gypsum panel (58) vertically thereto, and to cancel said protruding.

7. The gypsum board (10A) according to claim 2, wherein each of said anchors (28) is non-separable from the bolt (50) thereof, and
comprises a track (71), for sliding (52B) the bolt (50) thereof in relation to the anchor (28),
thereby allowing to protrude the bolt (50) from said second side (47A) of said gypsum panel (58) vertically thereto, and to cancel said protruding.

8. The gypsum board (10A) according to claim 1, wherein said fixing said anchors (28) to said gypsum panel (58) comprises solidifying liquid plaster (42) onto said anchors (28).
